(19) United States
(12) Patent Application Publication
(10) Pub. No.: US 2017/0223800 A1
(43) Pub. Date: Aug. 3, 2017

(54) LIGHT EMITTING MODULE, DIMMER SYSTEM AND CONTROLLER FOR COLOR TEMPERATURE MODULATION

(71) Applicant: TM TECHNOLOGY, INC, Hsinchu (TW)

(72) Inventors: Ben WU, Taipei City (TW); Wen-Tsung HO, Miaoli County (TW); Chih-Chun LIU, Taichung City (TW)

(73) Assignee: TM TECHNOLOGY, INC, Hsinchu (TW)

(21) Appl. No.: 15/161,063

(22) Filed: May 20, 2016

(30) Foreign Application Priority Data
Feb. 3, 2016 (TW) 105103636

(51) Int. Cl. H05B 33/08

(52) U.S. Cl. CPC H05B 33/0866; H05B 33/0845; H05B 33/083

(57) ABSTRACT

A light emitting module, a dimmer system and a controller for color temperature modulation are provided, and the dimmer system includes the light emitting module and the controller coupled to the light emitting module. The light emitting module includes a series of light emitting units. The light emitting unit includes a first light emitting diode (LED) for emitting light of a first color temperature, a second LED for emitting light of a second color temperature, and a switch connected to the second LED in series. The series circuit of the second LED and the switch is connected to the first LED in parallel. The switch is optionally turned on in response to a control signal. The controller optionally enables the light emitting units in a preset order. When enabling one of the light emitting units, the controller conducts the first LED.

### CROSS-REFERENCE TO RELATED APPLICATIONS

This non-provisional application claims priority under 35 U.S.C. §119(a) on Patent Application No(s). 105103636 filed in Taiwan, R.O.C. on Feb. 3, 2016, the entire contents of which are hereby incorporated by reference.

### BACKGROUND

Technical Field

The disclosure relates to a light emitting module and a dimmer system for color temperature modulation, and a controller for modulating the color temperature of light emitted by the light emitting module, more particularly to a light emitting module and a dimmer system for modulating a color temperature in a light mixing method, and a controller for modulating the color temperature of light emitted by the light emitting module.

Related Art

Owing to the rising awareness of environment protection, more and more people sense the importance of saving energy and reducing carbon emissions. This has recently caused the market share accounting for light emitting diodes (LEDs) having low power consumption and a long lifespan to increase year by year. However, although LEDs are environment-friendly, the usage of LEDs has some deficiencies. A LED is a single-color light source but the spectrum of natural light has various colors. Therefore, it is hard for LEDs to reach the effect of natural light; that is, the color rendering index of LEDs is insufficient.

Generally, the control manner of a LED focuses on modulating the color temperature of light emitted by the LED in accordance with different requirements. For example, the growth of a plant has different stages, and light of a different color temperature can timely affect a plant's physiological variation at a different stage to enable the efficient growth of the plant. For example, blue light may stimulate a plant's leaves to open their stomata at their lower surfaces, and red light may stimulate the photosynthesis of a plant.

The most direct way to change a luminous color temperature is to set the current for a LED. However, the property of light emitted by a LED has no linear relationship with a current. During the usage of a LED, it may be difficult to tune the color temperature to a desired level by setting a control signal produced by a linear circuit. Another way to control the radiation of a LED is to fast switch on/off the LED, wherein the most common practice is pulse width modulation (PWM), where the luminous property of the LED is controlled by changing the mean current, flowing through the LED, by modulating the ratio of turn-on to turn-off time periods in each switching cycle. However, fast switching on/off a LED is related to the control time sequence of the LED driving circuit and is more complicated to be practiced. Moreover, if a driving integrated circuit (driving IC) supports multiple control modes, the manufacturing cost must be high.

### SUMMARY

The present invention provides a light emitting module and a dimmer system for color temperature modulation and a controller for modulating the color temperature of light emitted by the light emitting module, to resolve the difficulty in the conventional means of controlling the luminous color temperature of the light emitting module including one or more LEDs, and provide a low-cost and simple control means to switch from one luminous color temperature to another.

According to one or more embodiments, a dimmer system for color temperature modulation includes a light emitting module and a controller. The controller is coupled to the light emitting module. The light emitting module includes a series of light emitting units. One of the light emitting units includes a first LED, a second LED and a switch. The switch is connected to the second LED in series. The series circuit of the second LED and the switch is connected to the first LED in parallel. The first LED is applicable to emit light of a first color temperature. The second LED is applicable to emit light of a second color temperature. The switch is applicable to selectively be turned on in response to a control signal. The controller is applicable to selectively enable the light emitting units, so the light emitting units emit light in a preset order. When the controller enables one of the light emitting units, the controller conducts the first LED.

According to one or more embodiments, a controller is applied to control a light emitting module to selectively emit light for color temperature modulation. The light emitting module is applied with an input voltage and includes (M+2) pieces of light emitting unit, one of which includes a first LED, a second LED and a switch connected to the second LED in series. The series circuit of the second LED and the switch is connected to the first LED in parallel. The first LED emits light of a first color temperature, and the second LED emits light of a second color temperature. The controller includes M pieces of first control unit, a detector, a current control unit and a color temperature modulator. Each of the first control units includes a first switch connected to one of the second to (M+1)th light emitting units in parallel. The current control unit is coupled to the Mth first control unit and the detector. The first switch selectively provides a bypass current path. The detector detects the potential of the input voltage to produce a current detection signal. The current control unit controls the Mth first control unit in response to the current detection signal to provide a predefined voltage to the first switch in the Mth first control unit so the first switch provides the bypass current path. The color temperature modulator selectively provides a control signal for selectively turning on the switch. When the first switch in the Mth first control unit does not provide the bypass current path, the Mth first control unit selectively controls the (M−1)th first control unit in response to the potential of the input voltage to provide the predefined voltage to the first switch in the (M−1)th first control unit. M is a positive integer larger than 1.

According to one or more embodiments, a light emitting module for color temperature modulation includes a series of first LEDs, a second LED and a switch. The second LED is coupled to the series of first LEDs. The switch is connected to the second LED in series, and the series circuit of the second LED and the switch is connected to at least one of the first LEDs in parallel. Each of the first LEDs emits light of a first color temperature. The second LED emits light of a second color temperature. The switch is selectively turned on in response to a control signal. The series of first LEDs is controlled to selectively be conducted in a preset order by the controller.

As set forth above, the present invention provides a light emitting module and a dimmer system for color temperature modulation and a controller for modulating the luminous color temperature of the light emitting module, to selectively radiate light of a second color temperature by selectively conducting one or more second LEDs. The light of the second color temperature is mixed with the light of a first color temperature to form the light of a desired color temperature. Therefore, the present invention may conquer the insufficient color rendering of LEDs and save additional costs on setting a different control time sequence or control mode for a different color temperature.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a dimmer system in an embodiment of the present invention;

FIG. 2A is a functional block diagram of a controller in an embodiment of the present invention;

FIG. 2B is a schematic circuit diagram of at least part of components in the controller in FIG. 2A;

FIG. 3A is a schematic spectrogram of first output light emitted by the dimmer system in an embodiment of the present invention;

FIG. 3B is a schematic spectrogram of second output light emitted by the dimmer system in FIG. 3A;

FIG. 3C is a schematic spectrogram of third output light emitted by the dimmer system in FIG. 3A;

FIG. 4A is a schematic spectrogram of fourth output light emitted by a dimmer system in another embodiment of the present invention; and

FIG. 4B is a schematic spectrogram of sixth output light emitted by the dimmer system in FIG. 4A.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

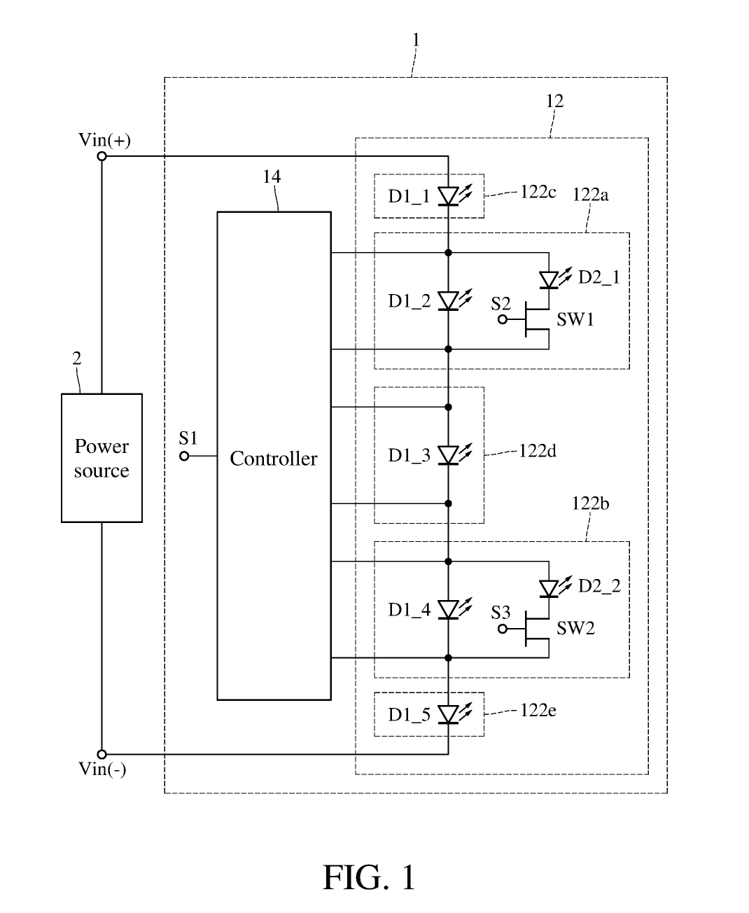

Please refer to FIG. 1, and FIG. 1 is a functional block diagram of a dimmer system in an embodiment of the present invention. As shown in FIG. 1, a dimmer system 1 for color temperature modulation includes a light emitting module 12 and a controller 14. The light emitting module 12 is coupled to the controller 14, and the light emitting module 12 and the controller 14 are coupled to a power source 2 that is used to provide an input voltage Vin. The light emitting module 12 includes a series of light emitting units 122a˜122e, the light emitting units 122a and 122b are grouped into a first illuminator set, and the light emitting units 122c˜122e are grouped into a second illuminator set.

In the case of the light emitting unit 122a, the light emitting unit 122a includes a first LED D1_2, a second LED D2_1 and a switch SW1. The second LED D2_1 is connected to the switch SW1 in series, and the series circuit of the second LED D2_1 and the switch SW1 is connected to the first LED D1_1 in parallel. The light emitting unit 122b is similar to the light emitting unit 122a in structure and thus, will not be described hereinafter. The first LEDs D1_2 and D1_4 both emit light of a first color temperature, and the second LEDs D2_1 and D2_2 both emit light of a second color temperature. The switch SW_1 is turned on in response to a control signal S2. The light emitting units 122c˜122e include the first LED D1_1, a first LED D1_3 and a first LED D1_5, respectively. The first LEDs D1_1, D1_3 and D1_5 all emit light of the first color temperature. In an embodiment, the light emitting units 122a and 122b may exclude the switches SW1 and SW2, respectively; that is, the first LED D1_2 is connected to the second LED D2_1 in parallel, and the first LED D1_4 is connected to the second LED D2_2 in parallel. At another aspect, the first LEDs D1_1˜D1_5 constitute a series of first LEDs, and the series circuit of the second LED D2_1 and the switch SW1 is connected to one of the first LEDs D1_1˜D1_5 in parallel while the series circuit of the second LED D2_2 and the switch SW2 is connected to another of the first LEDs D1_1˜D1_5 in parallel.

It is noted that the amount of each component in the embodiment in FIG. 1 is not limited to what FIG. 1 shows. For example, the dimmer system 1 may include M pieces of first LED, so the amounts of other components may be more or less. Additionally, in the embodiment in FIG. 1, the arrangement of the light emitting units 122a˜122e connected in series is not limited to what the drawing shows. In other words, the series circuit of the second LED D2_2 and the switch SW2 may optionally be connected to the first LED D1_5 in parallel or may optionally be connected to the series circuit of the first LED D1_4 and the first LED D1_5 in parallel.

The controller 14 conducts the first LEDs D1_1˜D1_5 in a preset order. In an embodiment, the controller 14 is commanded by a control signal S1 to periodically enable the first LEDs D1_1˜D1_5 by turns. When the first LEDs D1_1˜D1_5 are enabled, the first LEDs D1_1˜D1_5 will be driven to emit light by a driving current flowing therethrough. During a turned-on cycle, the first LEDs D1_1 and D1_5 are first conducted at the same time by the controller 14 before the controller 14 in order conducts the first LEDs D1_2, D1_3 and D1_4. A person skilled in the art should understand that during the last part of a turned-on cycle, the controller 14 in reverse order disables the first LEDs D1_1˜D1_5. In another embodiment, the controller 14 may periodically enable the first LEDs D1_1˜D1_5 in order. The above operation is only for an exemplary description, and a person skilled in the art can freely design the conducting sequence of the first LEDs D1_1˜D1_5 in view of the specification.

In practice, the controller 14 may selectively provide a bypass path by which the first LEDs D1_1˜D1_5 are selectively enabled. In an embodiment, in the case of the first LED D1_3, the controller 14 provides a bypass path connected to the first LED D1_3 in parallel, so the driving current flows through the bypass path rather than the first LED D1_3, and the first LED D1_3 is disabled and does not emit light. When the controller 14 does not provide the bypass path connected to the first LED D1_3 in parallel, the driving current will flow through the first LED D1_3, so the first LED D1_3 selectively emits light in response to the potential of the driving current. Similarly, the controller 14 may selectively enable the first LEDs D1_1, D1_2, D1_4 and D1_5 in the similar way, and it will not be described hereinafter.

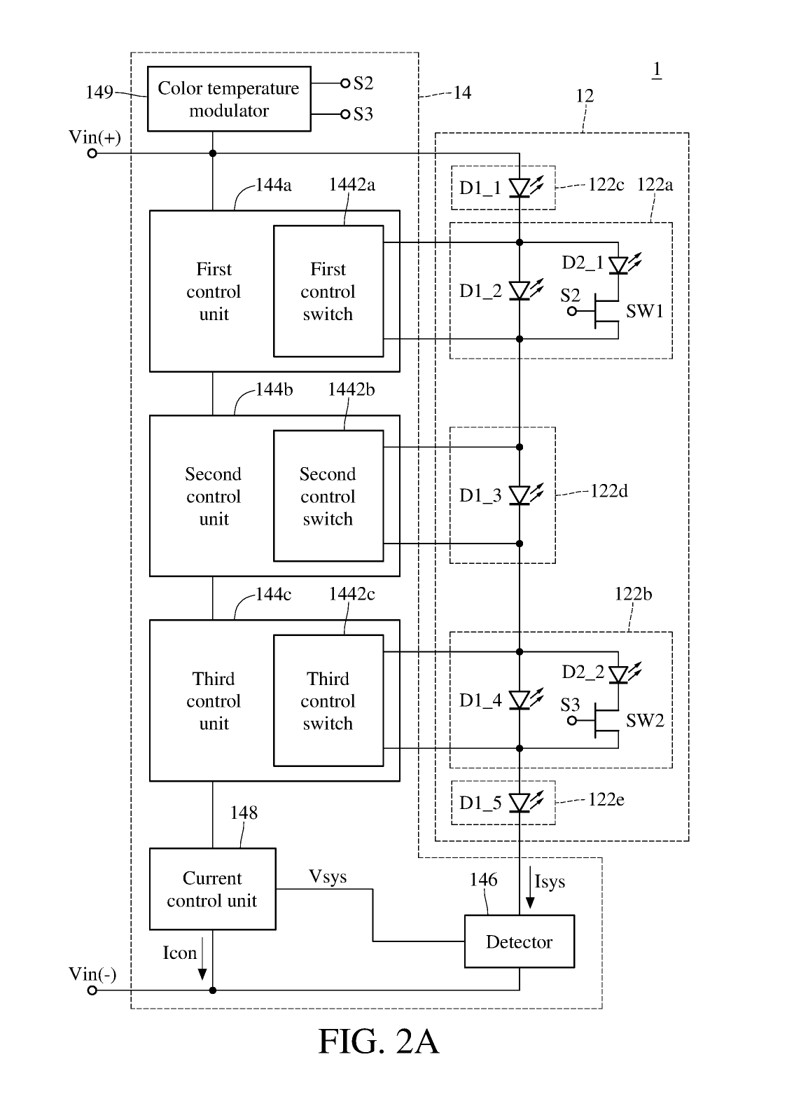

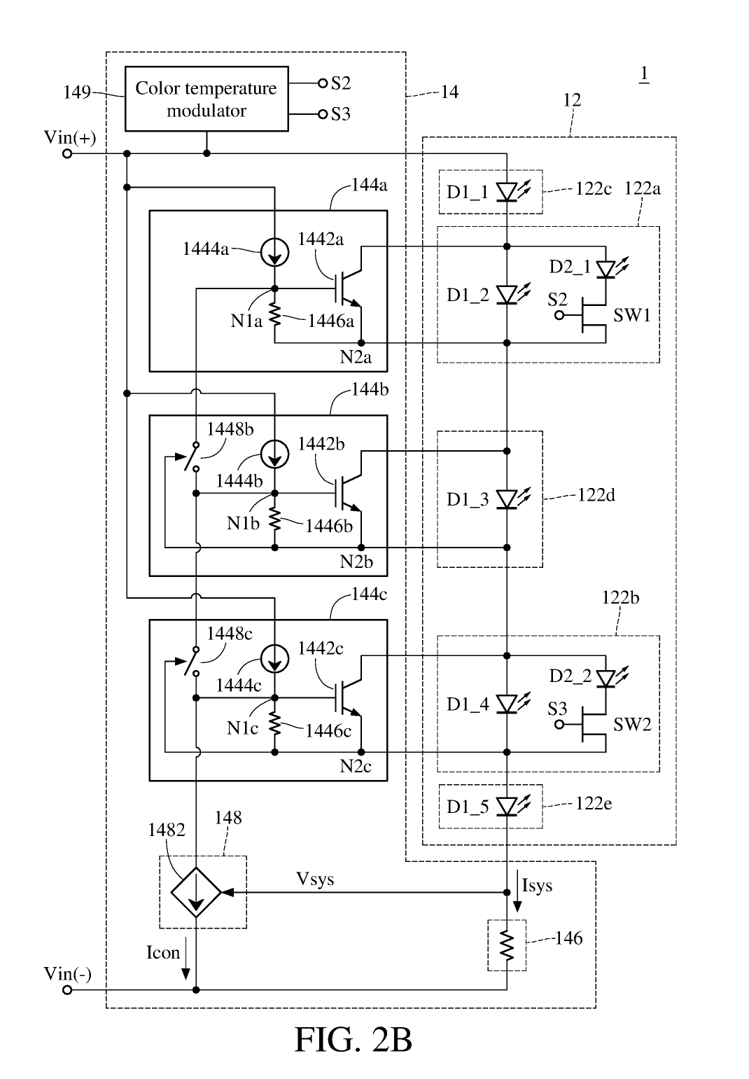

Please refer to FIG. 2A to clarify an implementation of the controller 14, and FIG. 2A is a functional block diagram of a controller in an embodiment of the present invention. As shown in FIG. 2A, the controller 14 includes first control units 144a˜144c, a detector 146 and a current control unit 148. The first control units 144a˜144c include first control switches 1442a˜1442c, respectively. The first control switches 1442a˜1442c are connected to the first LEDs D1_2˜D1_4 in parallel, respectively. The current control unit 148 is coupled to the third control unit 144c and the detector 146.

The first control units 144a˜144c selectively provide a bypass current path for the first LEDs D1_2˜D1_4. Particularly, the first control units 144a˜144c selectively provide a predefined voltage to the first control switches 1442a˜1442c. When the first control switches 1442a˜1442c receives the predefined voltage, the first control switches 1442a˜1442c will be turned on to form the bypass current path. In the drawing, the first control switches 1442a˜1442c are connected to the first LEDs D1_2˜D1_4 in parallel, respectively; therefore, when the first control switches 1442a˜1442c are turned on, instead of the first LEDs D1_2˜D1_4, the current will flow toward the bypass current path and the first LEDs D1_2˜D1_4 will not emit light.

The detector 146 detects a current Isys formed by the input voltage Vin applied to the parallel connection of the LED and the switch, to produce a current detection signal Vsys. In this embodiment, the detector 146 generates the current detection signal Vsys according to the current Isys. For example, the detector 146 is a resistor, the current Isys is a current flowing through the series of first LEDs D1_1˜D1_5, and the current detection signal Vsys is a voltage signal formed by the current Isys flowing through the detector 146. In practice, a person skilled in the art can freely design the detection means of the detector 146 in view of the disclosure, and the present invention is not limited to define the current detection signal Vsys as a voltage signal, a current signal or another type of signal.

The current control unit 148 controls the third control unit 144c in response to the current detection signal Vsys to provide the predefined voltage to the third control switch 1442c, so as to selectively turn on the third control switch 1442c for the bypass current path.

When the third control unit 144c does not use the third control switch 1442c to provide a bypass current path, the third control unit 144c may in response to the potential of the input voltage Vin, selectively control the second control unit 144b to provide a predefined voltage to the second control switch 1442b for enabling a related bypass current path. Particularly, when the input voltage Vin is larger than a preset threshold, the third control unit 144c controls the second control unit 144b to turn off the second control switch 1442b, so the second control switch 1442b will not provide any bypass current path.

As described above, the current flows through the first LED D1_4 so that the first LED D1_4 emits light.

Likewise, when the second control switch 1442b in the second control unit 144b does not provide any bypass current path, the second control unit 144b selectively controls the first control unit 144a to provide a predefined voltage to the first control switch 1442a in response to the potential of the input voltage Vin. A person skilled in the art can understand that in the case of the dimmer system 1 including M pieces of first control unit and M pieces of first LED, when the ith first control unit does not provide any bypass current path, the ith first control unit may in response to the potential of the input voltage Vin, selectively control the (i−1)th first control unit to provide a bypass current path; and i is a positive integer larger than 1 but not larger than M.

Please refer to FIG. 2B to illustrate the circuit of the illuminator in detail, and FIG. 2B is a schematic circuit diagram of at least part of components in the controller in FIG. 2A. As shown in FIG. 2B, the first control unit 144a, the second control unit 144b and the third control unit 144c all include multiple components. In the case of the third control unit 144c, the third control unit 144c further includes a constant current source 1444c, a first resistor 1446c and a switch 1448c. The current control unit 148 in this embodiment includes a voltage-controlled current source 1482.

The constant current source 1444c is coupled to and between the input voltage Vin and a first node N1c. The two terminals of the first resistor 1446c are coupled to the first node N1c and a second node N2c. The switch 1448c is coupled to the first node N1c and a first node N1b of the second control unit 144b. The switch 1448c is controllable to selectively conduct the connection between the first node N1c and the first node N1b in response to the voltage on the second node N2c for a relevant shunt path. The voltage on the second node N2c is a fraction of the input voltage Vin, which is applied to the second node N2c.

Additionally, the two terminals of the third control switch 1442c are electrically connected to the second node N2c and the second node N2b in the second control unit 144b, respectively, and the control terminal of the third control switch 1442c is coupled to the first node N1c. In the figure, the cathode of the first LED D1_4 is coupled to the second node N2c, and the anode of the first LED D1_4 is coupled to the second node N2b. Therefore, the third control switch 1442c is controllable to selectively conduct the connection between the second node N2c and the second node N2b in response to the voltage on the first node N1c for a bypass current path.

In the embodiment shown in FIG. 2B, each of the first LEDs D1_1˜D1_5 has a preset threshold related to the input voltage Vin. When the input voltage Vin is larger than a related preset threshold, one or more of the first LEDs D1_1˜D1_5 may be driven to emit light. The preset thresholds of the first LEDs D1_2˜D1_4 are arranged from large to small. In other words, the preset threshold of the first LED D1_4 is less than the preset threshold of the first LED D1_3, and the preset threshold of the first LED D1_3 is less than the preset threshold of the first LED D1_2. Therefore, with the increase of the input voltage Vin, the first LEDs D1_1 and D1_5 are conducted first, and then the first LEDs D1_4, D1_3 and D1_2 are conducted in order.

More particularly, if a fraction of the input voltage Vin applied to the second node N2c is larger than the preset threshold of the second node N2c, the third control unit 144c enables a shunt path, and the current control unit 148 also increases a control current Icon according to the current detection signal Vsys to guide the output current of the second control unit 144b toward the shunt path in the third control unit 144c. That is, the output current of the constant current source 1444b is guided toward the shunt path in the third control unit 144c, so the second control switch 1442b is turned off and the first LED D1_3 emits light. When the third control unit 144c does not enable a related shunt path, the output current of the constant current source 1444b in the second control unit 144b flows through the first resistor 1446b, whereby a predefined voltage is applied on the first node N1b to turn on the second control switch 1442b for a bypass current path. Therefore, the first LED D1_3 does not emit light.

In other words, when the potential of the input voltage Vin is increasing, the third control unit 144c selectively provides a related bypass current path in response to the input voltage Vin and the control current Icon, and the third control unit 144c and the second control unit 144b sequentially enable a related shunt path in response to the input voltage Vin, the current control unit 148 correspondingly increases the potential of the control current Icon on the shunt path to activate the first LED D1_3 or the first LED D1_2. Similarly, when the potential of the input voltage Vin is decreasing, the second control unit 144b and the third control unit 144c sequentially disable the related shunt path in response to the input voltage Vin, the current control unit 148 correspondingly lowers the potential of the control current Icon to sequentially turn off the first LEDs D1_2 and D1_3. Then, the third control unit 144c provides a related bypass current path in response to the input voltage Vin as well as the control current Icon so that the first LED D1_4 is turned off. Finally, the first LEDs D1_1 and D1_5 are turned off.

In an embodiment, the controller 14 further includes a color temperature modulator 149. The color temperature modulator 149 is coupled to the input voltage Vin and is used to produce control signals S2 and S3. In another embodiment, the color temperature modulator 149 is further used to receive the control signal S1 and modulate the control signals S2 and S3 according to the control sequence indicated by the control signal S1, so the second LEDs D2_1 and D2_2 selectively emit light in the luminous order of the first LEDs D1_1˜D1_5.

Next, as shown in FIG. 1, the switches SW1 and SW2 are selectively turned on in response to the control signals S2 and S3, respectively. In the case of the switch SW1 in FIG. 1, when the switch SW1 is turned on by the control signal S2, the second LED D2_1 and the first LED D1_2 may be considered as a parallel circuit if the turn-on voltage of the switch SW1 is ignored. Herein, the second LED D2_1 selectively emits light in response to the current flowing through the first LED D1_2. As described above, while the first LED D1_2 is selectively enabled in response to the command of the controller 14, a turn-on current flows through the first LED D1_2. In other words, when the switch SW1 is turned on, the second LED D2_1 is also conducted in response to the command of the controller 14. Therefore, the luminous intensities of the first LED D1_2 and the second LED D2_1 are related to the potential of the shunted current. However, the present invention is not limited to the percentage of the driving current occupied by the shunted current, which may be defined according to the turn-on voltage of the parallel circuit of two diodes.

In the previous description, the control signals S2 and S3 are the same or different; that is, the switches SW1 and SW2 are not limited to be simultaneously turned on or be turned on at different time. In the consideration to whether the switches SW1 and SW2 are turned on or not and to the difference between the first and second color temperatures, the dimmer system 1 may tune its output light's color temperature to a desired mean color temperature.

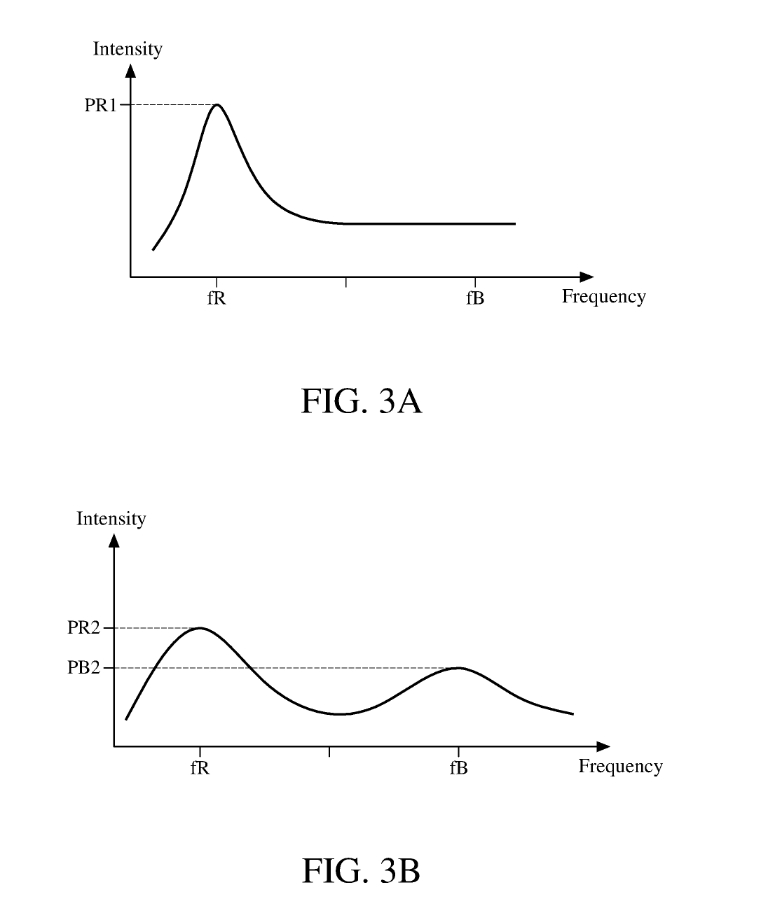

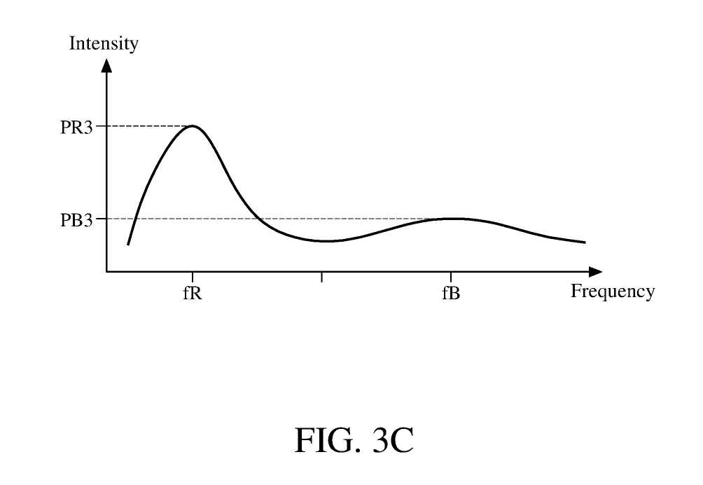

Please refer to FIGS. 3A, 3B and 3C, FIG. 3A is a schematic spectrogram of first output light emitted by the dimmer system in an embodiment of the present invention, FIG. 3B is a schematic spectrogram of second output light emitted by the dimmer system in FIG. 3A, and FIG. 3C is a schematic spectrogram of third output light emitted by the dimmer system in FIG. 3A. In an embodiment, the first LEDs D1_1˜D1_5 are red LEDs, and the second LEDs D2_1 and D2_2 are blue LEDs. The details of the first LEDs D1_1˜D1_5 and the second LEDs D2_1 and D2_2 are listed in the following table:

| | First LED | | | | |
|---|---|---|---|---|---|
| | D1_1 | D1_2 | D1_3 | D1_4 | D1_5 |
| Color of light | Red | Red | Red | Red | Red |
| | Second LED | | | | |
| | NA | D2_1 | NA | D2_2 | NA |
| Color of light | NA | Blue | NA | Blue | NA |

It is noted that the red light and blue light are related to the variance in color, and the present invention is not limited to the accurate frequencies of red light and blue light. The reference frequencies fR, fB and fG will be used to compare the red, blue and green light with each other later. The reference frequency fR is related to red light, the reference frequency fB is related to blue light, and the reference frequency fG is related to green light. The reference frequency fR is less than the reference frequency fG, and the reference frequency fG is less than the reference frequency fB. Moreover, a person skilled in the art can understand that a different material or structure can lead to a different turn-on voltage of each of the first LEDs D1_1˜D1_5 and the second LEDs D2_1 and D2_2, and the relevant details will not be described hereinafter.

When the switches SW1 and SW2 are turned off, the dimmer system 1 emits first output light. The spectrum of the first output light is shown in FIG. 3A. Because the dimmer system 1 emits light via only the first LEDs D1_1˜D1_5 when the switches SW1 and SW2 are turned off, the first output light is substantially red light. In other words, the energy of the first output light may be centralized at the reference frequency fR of red light, so the spectrum of the first output light has a peak value PR1 at about the reference frequency fR.

When the switches SW1 and SW2 are simultaneously turned on, the dimmer system 1 emits second output light. The spectrum of the second output light is shown in FIG. 3B. The second LED D2_1 selectively emits light in response to the shunted current of the driving current to the first LED D1_2, and the second LED D2_2 selectively emits light in response to the shunted current of the driving current to the first LED D1_4. Also, the driving currents respectively flowing through the first LEDs D1_2 and D1_4 become less because of being shunted. Therefore, on average the second output light emitted by the dimmer system 1 herein has less red light and more blue light than the first output light.

The energy of the second output light may be centralized at about the reference frequency fR of red light and the reference frequency fB of blue light, so the spectrum of the second output light has a peak value PR at about the reference frequency fR and a peak value PB at about the reference frequency fB.

When only one of the switches SW1 and SW2 is turned on, the dimmer system 1 emits third output light. The spectrum of the third output light is shown in FIG. 3C. Likewise, on average the third output light has less red light and more blue light than the first output light. However, the driving current to one of the first LEDs D1_2 and D1_4 is not shunted to drive the second LEDs D2_1 and D2_2, so the third output light has more red light and less blue light than the second output light. Therefore, the peak value PR1 is larger than the peak value PR3, the peak value PR3 is larger than the peak value PR2, and the peak value PB2 is larger than the peak value PB3.

Accordingly, in view of FIGS. 3A, 3B and 3C and the relevant description, when at least one of the switches SW1 and SW2, the output light of the dimmer system 1 has more blue light and less red light. When more of the switches SW1 and SW2 are turned on, the variations of the blue light and red light in the output light of the dimmer system 1 become more significant.

As described above, all of the turn-on voltages of the first LEDs D1_1˜D1_5 and the second LEDs D2_1 and D2_2 are not the same, so when the switches SW1 and SW2 are turned on, all of the voltages on the first LEDs D1_1˜D1_5 and the second LEDs D2_1 and D2_2 and all of the luminous intensities of the first LEDs D1_1˜D1_5 and the second LEDs D2_1 and D2_2 are not the same. In an embodiment, the dimmer system 1 adjusts the voltages on the second LEDs D2_1 and D2_2 by modulating the control signals S2 and S3, to tune the light emitted by the second LEDs D2_1 and D2_2, respectively. Specifically, in an embodiment, the switches SW2 and SW3 are metal-oxide-semiconductor (MOS) transistors, the gate electrodes of the switches SW2 and SW3 respectively receive the control signals S2 and S3, and the voltage potentials of the control signals S2 and S3 are controlled by an external device or the controller 14. When the voltage potentials of the control signals S2 and S3 change, the difference between the drain electrode and source electrode of the switch SW2 and the difference between the drain electrode and source electrode of the switch SW3 also change, so the voltages on the second LEDs D2_1 and D2_2 change and the light emitted by the second LEDs D2_1 and D2_2 also changes.

In addition, in an embodiment, if the first LED D1_5 is replaced by another second LED, the output light of the dimmer system 1 still has blue light when the switches SW1 and SW2 are turned off. Likewise, in this embodiment, the first LED is connected to this second LED in parallel, and the percentage of each color light in the output light of the dimmer system 1 is adjusted by selectively turning on the related one or more switches.

In addition to the first LEDs D1_1˜D1_5 for emitting light of the first color temperature and the second LEDs D2_1 and D2_2 for emitting light of the second color temperature, the dimmer system 1 may further include a third LED for emitting light of a third color temperature. The third LED may be arranged in the foregoing series of LEDs. Optionally, the series circuit of the third LED and a switch may be connected to one of the first LEDs D1_1˜D1_5 in parallel, and this parallel circuit is similar to the structures of the light emitting units 122a and 122b.

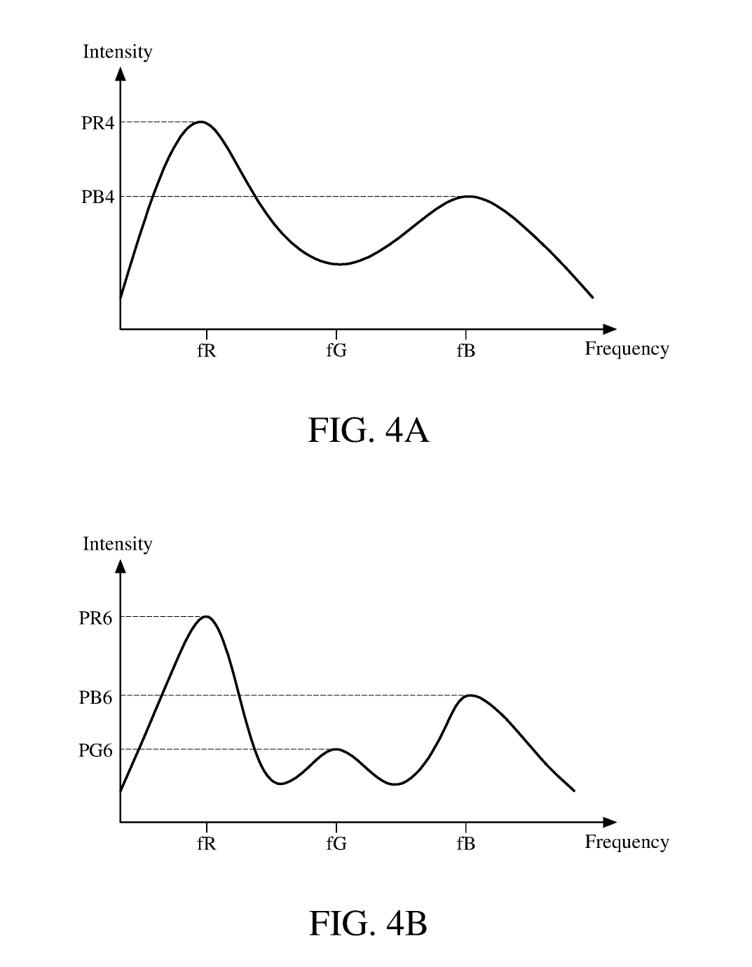

Please refer to FIGS. 4A and 4B, FIG. 4A is a schematic spectrogram of fourth output light emitted by a dimmer system in another embodiment of the present invention, and FIG. 4B is a schematic spectrogram of sixth output light emitted by the dimmer system in FIG. 4A. In the embodiment with respect to FIGS. 4A and 4B, the first LEDs D1_1˜D1_3 and D1_5 are red LEDs, the first LED D1_4 is replaced by a second LED D2_3 that is a blue LED for emitting light of the second color temperature, and the second LED D2_2 is replaced by a third LED D3_1 that is a green LED for emitting light of a third color temperature. The details of the LEDs are listed in the following table:

| | First LED | | | | |
|---|---|---|---|---|---|
| | D1_1 | D1_2 | D1_3 | D2_3 | D1_5 |
| Color of light | Red | Red | Red | Blue | Red |
| | Second LED | | | | |
| | NA | D2_1 | NA | D3_1 | NA |
| Color of light | NA | Blue | NA | Green | NA |

As described above, when the switches SW1 and SW2 are turned off, the dimmer system 1 emits fourth output light having red light and blue light. As shown in FIG. 4A, the spectrum of the fourth output light has a peak value PR4 at about the reference frequency fR of red light and a peak value PB4 at about the reference frequency fB of blue light.

When only the switch SW1 is turned on, the dimmer system 1 emits fifth output light. The spectrum of the fifth output light has a peak value PR5 at about the reference frequency fR of red light and a peak value PB5 at about the reference frequency fB of blue light. As compared to the fourth output light, the fifth output light has less red light and more blue light. The peak value PR4 is higher than the peak value PR5, and the peak value PB4 is lower than the peak value PB5.

When only the switch SW2 is turned on, the dimmer system 1 emits sixth output light. The spectrum of the sixth output light is shown in FIG. 4B and has a peak value PR6 at about the reference frequency fR of red light, a peak value PB6 at about the reference frequency fB of blue light and a peak value PG6 at about the reference frequency fG of green light. As compared to the fourth output light, the sixth output light has less blue light and more green light. The peak value PB4 is higher than the peak value PB6, and the peak value PR4 is substantially equal to the peak value PR6.

When both of the switches SW1 and SW2 are turned on, the dimmer system 1 emits seventh output light. The spectrum of the seventh output light has a peak value PR7 at about the reference frequency fR of red light, a peak value PB7 at about the reference frequency fB of blue light and a peak value PG7 at about the reference frequency fG of green light. As compared to the fourth output light, the seventh output light has fewer red light, substantially-equal blue light and more green light. That is, the peak value PR4 is higher than the peak value PR7, and the peak value PB4 is substantially equal to the peak value PB7.

Therefore, the ratio of different color contents in the output light of the dimmer system 1 is adjusted by disposing the LEDs in the light emitting units 122a˜122e and selectively switching on or off the switches SW1 and SW2, so the mean color temperature of the output light of the dimmer system 1 is then adjusted. Moreover, the dimmer system 1 only needs to control the switches SW1 and SW2, without significantly redesigning the driving IC. Also, because what percentage of the driving current accounting for the shunted current is defined based on the turn-on voltage of the two LEDs connected in parallel and thus, is related to the manufacturing of the LEDs. Therefore, the present invention is not limited to the values of the peak values PR1˜PR7, PB2˜PB7 and PG6˜PG7 and the ratio of different color contents in the output light of the dimmer system 1.

The previous embodiments are only for exemplary descriptions, and a person skilled in the art can in view of the disclosure understand that the first LEDs D1_1˜D1_5 and the second LEDs D2_1 and D2_2 can be replaced by other LEDs emitting light of other colors.

To sum up, the present invention provides a light emitting module and a dimmer system for color temperature modulation and a controller for controlling the color temperature of light emitted by the light emitting module. The series circuit of a second LED and a switch is connected to a first LED in parallel, and while the first LED is conducted to emit light of a first color temperature, the second LED is selectively conducted to selectively emit light of a second color temperature. The light of the second color temperature and the light of the first color temperature are mixed to form the light of a desired color temperature. Adjusting the amount of enabled first LEDs and the amount of enabled second LEDs or adjusting the ratio of the luminous intensity of the one or more enabled first LEDs to the luminous intensity of the one or more enabled second LEDs may lead to a desired color temperature of the dimmer system. Moreover, in an embodiment, one or more third LEDs for emitting light of a third color temperature are added, so the adjustable range of the color temperature of the dimmer system may be extended. Therefore, the dimmer system may conquer the insufficient color rendering of LEDs and may save additional costs on setting a different control time sequence or control mode for a different color temperature since the dimmer system only needs to control a related switch.

What is claimed is:

1. A dimmer system for color temperature modulation, comprising:
a light emitting module comprising light emitting units which are connected in series to constitute a series circuit, and one of the light emitting units comprising:
a first light emitting diode for emitting light of a first color temperature;
a second light emitting diode for emitting light of a second color temperature; and
a switch connected in series to the second light emitting diode, the series circuit being connected to the first light emitting diode in parallel, and the switch configured to being selectively turned on in response to a control signal; and
a controller coupled to the light emitting module and selectively enabling the light emitting units to emit light in a preset order;
wherein, when the controller enables one of the light emitting units, the controller turns on the first light emitting diode.

2. The dimmer system according to claim 1, wherein another of the light emitting units comprises a first light emitting diode.

3. The dimmer system according to claim 1, wherein the first one and the last one of the series of the light emitting units are first and simultaneously turned on to emit light.

4. The dimmer system according to claim 1, wherein the control signal is provided by the controller.

5. A controller for controlling a light emitting module to selectively emit light, the light emitting module for being applied with an input voltage and comprising (M+2) pieces of light emitting unit, one of which comprises a first light emitting diode for emitting light of a first color temperature, a second light emitting diode for emitting light of a second color temperature, and a switch connected to the second light emitting diode in series to constitute a series circuit that is connected to the first light emitting diode in parallel, and the controller comprises:
M pieces of first control unit, each of which comprises a first switch connected to one of the second to (M+1)th light emitting units in parallel for selectively providing a bypass current path;
a detector for detecting a potential of the input voltage to produce a current detection signal;
a current control unit coupled to the Mth first control unit and the detector, for in response to the current detection signal controlling the Mth first control unit to provide a predefined voltage to the first switch in the Mth first control unit so the Mth first control unit provides the bypass current path; and
a color temperature modulator for selectively provide a control signal for selectively turning on the switch;
wherein when the first switch in the Mth first control unit does not provide the bypass current path, the Mth first control unit controls the (M−1)th first control unit in response to the potential of the input voltage to provide the predefined voltage to the first switch in the (M−1)th first control unit, and M is a positive integer larger than 1.

6. The controller according to claim 5, wherein another of the light emitting units comprises a first light emitting diode.

7. A light emitting module for color temperature modulation, comprising:
a series of first light emitting diodes, each of which emits light of a first color temperature;
a second light emitting diode coupled to the series of first light emitting diodes, for emitting light of a second color temperature; and
a switch connected to the second light emitting diode in series to constitute a series circuit that is connected to at least one of the first light emitting diodes in parallel, and the switch configured to be turned on in response to a control signal;
wherein the series of first light emitting diodes is controlled by a controller to selectively be conducted in a preset order.

8. The light emitting module according to claim 7, wherein the first one and the last one of the series of first light emitting diodes are first and simultaneously turned on.

9. The light emitting module according to claim 7, wherein the control signal is provided by the controller.
